(19) United States
(12) Patent Application Publication
(10) Pub. No.: US 2017/0161345 A1
(43) Pub. Date: Jun. 8, 2017

(54) DATABASE INTERFACE AND MANAGEMENT SYSTEM

(71) Applicant: Datanova Scientific LLC, Baltimore, MD (US)

(72) Inventor: Sameer Joshi, Baltimore, MD (US)

(21) Appl. No.: 15/368,009

(22) Filed: Dec. 2, 2016

Related U.S. Application Data
(60) Provisional application No. 62/262,007, filed on Dec. 2, 2015.
(60) Provisional application No. 62/428,880, filed on Dec. 1, 2016.

(51) Int. Cl. G06F 17/30

(52) U.S. Cl. CPC G06F 17/30569; G06F 17/30554; G06F 17/30477; G06F 17/30312

(57) ABSTRACT

A method of querying a database includes: receiving, from a user device, a user query formatted in accordance with a target construct, the target construct having one of an ontological construct or a schematic construct; translating the user query into a source query formatted in accordance with a source construct, the source construct having the other of the ontological construct or the schematic construct; querying, using a programmable processor, a database using the source query and obtain source results from the database, the database and the source results formatted in accordance with the source construct; transforming the source results into target results formatted in accordance with the target construct; and returning, to the user device, the target results.

### CROSS REFERENCE TO RELATED APPLICATIONS

Priority is claimed U.S. Provisional Patent Application Ser. No. 62/262,007, filed Dec. 2, 2015, and to U.S. Provisional Patent Application Ser. No. 62/428,880, filed Dec. 1, 2016. The disclosures of the aforementioned priority applications are incorporated herein by reference in their entireties.

### FIELD OF THE INVENTION

The field of the present invention relates to database interface, database management, and data integration systems.

### BACKGROUND OF THE INVENTION

All columnar databases provide very little logical structuring of data outside of rows and columns. At the same time, columnar databases allow a high degree of freedom in structuring the data. Structures like columns and column families may be added dynamically, and data may be stored in the column name or column value. In order to support complex access patterns, intelligently structured keys are required. Importantly, there are no inbuilt processes or mechanisms to support the formal definition of physical data models, schemas, or access patterns. Instead, programmatic clients, such as Java®, are required to supply all the application schema logic. The use of a programmatic client with columnar databases does not meet the complexity required by large data systems, in which various interlinked schemas are required.

Even other databases which structure data using a simple tree logic suffer from the same setbacks of not scaling well to the complexity required by large organizations.

Technologies which scale well to the complexity required by large organizations, such as semantic (ontological) technologies, which encode meanings separately from data and content files, and separately from application code, are not generally concerned with the setup and management of databases and data information systems. They do not provide any database management primitives, nor do they provide any database schemas for interfacing with a database. Thus, a need exists for database interface and management systems which provide databases with the big data scale of columnar, key value, or tree databases, combines with the sophistication enabled by semantic technologies.

### SUMMARY OF THE INVENTION

The present invention is directed toward processes for interfacing and managing data using multiple models and construct maps which provide mappings between the different models. The models may have an ontological construct or a schematic construct, and the construct maps may map between any two models, regardless of the construct of the models.

In a first separate aspect of the present invention, a method of querying a database includes: receiving, from a user device, a user query formatted in accordance with a target construct, the target construct having one of an ontological construct or a schematic construct; translating the user query into a source query formatted in accordance with a source construct, the source construct having the other of the ontological construct or the schematic construct; querying, using a programmable processor, a database using the source query and obtain source results from the database, the database and the source results formatted in accordance with the source construct; transforming the source results into target results formatted in accordance with the target construct; and returning, to the user device, the target results.

In a second separate aspect of the present invention, a method of querying a database includes: receiving, from a user device, a user query formatted in accordance with a target construct, the target construct having one of an ontological construct or a schematic construct; translating the user query into a source query formatted in accordance with a source construct, the source construct having the other of the ontological construct or the schematic construct; and querying, using a programmable processor, a database using the source query to return source results from the database, the database and the source results formatted in accordance with the source construct.

In a third separate aspect of the present invention, a method of retrieving query results from a database includes: querying, using a programmable processor, the database using a source query, the query returning source results from the database, the database and the source results formatted in accordance with a source construct, the source construct having one of an ontological construct or a schematic construct; transforming the source results into target results formatted in accordance with a target construct, the target construct having the other of the ontological construct or the schematic construct; and returning, to a querying device, the target results.

Accordingly, an improved database interface and management system is disclosed. Advantages of the improvements will be apparent from the drawings and the description herein.

### BRIEF DESCRIPTION OF THE DRAWINGS

The foregoing summary, as well as the following detailed description of the exemplary embodiments, will be better understood when read in conjunction with the appended drawings. It should be understood, however, that the invention is not limited to the precise arrangements and instrumentalities shown in the following figures:

FIG. 1 schematically illustrates an exemplary system for interfacing with and managing a database;

FIG. 2 schematically illustrates a process for interfacing with a database;

FIG. 3 is a flowchart showing a first embodiment of a database querying process;

FIG. 4 is a flowchart showing a first embodiment of a query translation process for translating a database query from a first construct to a second construct;

FIG. 5 is a flowchart showing a first embodiment of a data transform process for transforming query results from a second construct to a first construct;

FIG. 6 is a flowchart showing a first embodiment of a value transformation process that may be incorporated into the as part of the data transform process of FIG. 5;

FIGS. 7A-B are a flowchart showing a second embodiment of a query translation process for translating a database query from a first construct to a second construct;

FIGS. 8A-B are a flowchart showing a second embodiment of a data transform process for transforming query results from a second construct to a first construct; and

FIGS. 9A-B are a flowchart showing a second embodiment of a value transformation process that may be incorporated into the as part of the data transform process of FIG. 8.

### DETAILED DESCRIPTION OF THE INVENTION

The following description of embodiment(s) of the invention is merely exemplary in nature and is in no way intended to limit the invention, its application, or uses.

Features of the present invention may be implemented in software, hardware, firmware, or combinations thereof. The programmable processes described herein are not limited to any particular embodiment, and may be implemented in an operating system, application program, foreground or background processes, driver, or any combination thereof. The computer programmable processes may be executed on a single processor or on or across multiple processors.

Processors described herein may be any central processing unit (CPU), microprocessor, micro-controller, computational, or programmable device or circuit configured for executing computer program instructions (e.g. code). As used herein, the terms “processor” and “programmable processor” are used interchangeably. Various processors may be embodied in computer and/or server hardware of any suitable type (e.g. desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g. software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs is referred to hereinafter as a “programmable device”, or just a “device” for short, and multiple programmable devices in mutual communication is referred to as a “programmable system”. It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g. internal/external hard drives, RAM drives, floppy discs, magnetic tape CD-ROM, DVD-ROM, optical disc, Blu-ray disc, network attached storage, among others), which may be written to and/or read by a processor operably connected to the medium.

In certain embodiments, the present invention may be embodied in the form of computer-implemented processes and apparatuses such as processor-based data processing and communication systems or computer systems for practicing those processes. The present invention may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

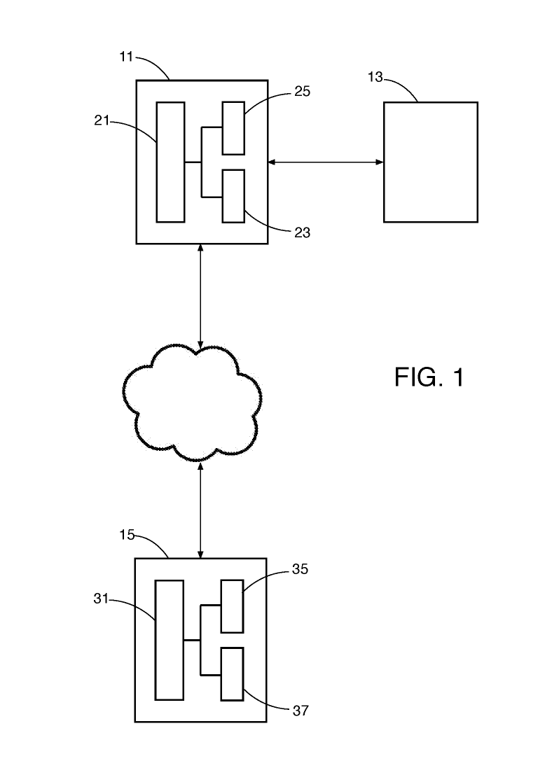

A system for interfacing with and managing a database is illustrated in FIG. 1. The system includes a server 11 in communication with a database 13. The server 11 is a programmable device which operates in a networked environment to interact with other programmable devices and networks. In certain embodiments, the server 11 may be in communication with multiple databases, with the processes described herein enabling interfacing with and/or management of more than one of the databases simultaneously. As shown, the server 11 communicates over the network 15 with the user device 17. The database 13 may be maintained in the storage of the server 11, or it may maintained on other storage that is accessible, by the server 11. The network 15 may include a private network, a public network, such as the Internet, or any combination of public and private networks. In addition, the network 15 may be a wired network, a wireless network, or any combination of wired and wireless networks.

The server 11 in the embodiment shown includes a processor 21, volatile storage 23, and non-volatile storage 25. The processor 21 may use one or both of the volatile storage 23 and the non-volatile storage 25 as operating memory. As such, one or both of the volatile storage 23 and the non-volatile storage 25 may include one or more memory spaces, with each memory space being separately addressable by the processor 21. Additional processors, volatile storage, and non-volatile storage may be included as desired based on specifications of a particular implementation, and any such additional processors, volatile storage, and non-volatile storage may coupled directly to the processor 21, or they may be coupled to the processor 21 over the network 15 or any other network. Having additional processors, volatile storage, and non-volatile storage coupled to the processor 21 over the network 15 enables a distributed computing model for the processes described herein.

The user device 17 is another programmable device which communicates using the network 15. Although the server 11 may be networked to multiple user devices simultaneously, in order to allow interfacing with and management of the database 13 by multiple users, only one is shown for purposes of simplifying the ensuing description. The user device 17 serves as an access point for a user to interface with and/or manage the database 13 through the server 11. As shown, the user device 17 includes a processor 31, volatile storage 33, and non-volatile storage 35. The user device 17 may be any type of programmable device, such as any desktop or mobile device, such as a workstation, a desktop computer, a laptop computer, a notebook, a tablet, a cellular phone, and the like. The server 11 may use any desired protocols and file formats to electronically communicate with the user device 17 that are deemed appropriate for the specifications of a particular implementation. For example, the server 11 may implement one or more application programming interfaces (APIs) which enable the user device 17 to interact with the database 13.

Certain types of data stores, such as columnar databases, JSON or XML databases, and relational databases, may be described by schematic constructs which reflect the data structures and access patterns for such a database. A schematic construct provides a structure that is generally efficient for storage and access by programmable systems. The schematic construct itself can reflect the generic logical structure of the data and can therefore serve as a map to the database itself. As a result, a schematic construct may be defined by a nested and/or repeated scheme. By way of example, for a wide column database, the row may be used as an identifier that groups a set of columns, a column may define an attribute belonging to a row, and the values stored within the may be identified by the row and column. Extensible Markup Language (XML) is a known example of a language which may be used to create a schematic construct for such types of databases. However, XML cannot map to specific characteristics of wide column databases—such as the data being stored in the column name. Different data stores have unique sets of parameters which are used to interact with the data stores, e.g. run queries, write new data, etc. For each data store having a schematic construct, this unique set of parameters is referred to herein as a “scheme construct”. Scheme constructs enable the creation of arbitrary constructs on wide-column data stores using a machine readable and formal definition.

Other types of data stores have an ontological construct. In these data stores, the data is stored with meanings, concepts, and relationships that represent the content and structure of the data store. Such meanings, concepts, and relationships are generally independent from the data itself. A data store having an ontological construct provides a way of interacting with data that is generally viewed as being efficient for humans. A data store having an ontological construct may be defined by ontological classes, class properties, and data type properties, such that each data store having an ontological construct may have a unique set of parameters to define the particular ontological classes, class properties, and data type properties of that data store. For each data store having an ontological construct, this unique set of parameters is referred to herein as a “model construct”. Model constructs enable the creation of arbitrary constructs, through a formal definition language, on ontological data stores using machine readable documentation.

One aspect of the invention disclosed herein is the creation and use of map constructs which enable the exchange of data and information (e.g. queries) between one or more other types of constructs. For example, a map construct called an S2S construct allows mapping and transformation from one scheme construct to another scheme construct. S2S constructs focus on mapping the physical aspects of data from one schematic construct to another schematic construct. As such, S2S constructs may be used for purposes of data integration, transformation, and the like.

As another example, a scheme construct may be mapped to a model construct by a map construct called an S2M construct. An S2M construct allows the reference, representation, manipulation, management, and transformation of data formatted according to a schematic construct through the use of a model construct. Generally, an S2M construct maps data from the format of a schematic construct to the format of an ontological construct. This is essentially mapping the physical form of the data to its meaning, allowing the creation of semantic entities from physical data. Such a mapping allows a user to interact with the data through the meanings, concepts, and relationships of an ontological construct. An S2M construct therefore allows a query based on the meaning of data to be translated to a query based on the physical data structures.

Conversely, a model construct may be mapped to a scheme construct by a map construct called an M2S construct. An M2S construct allows the reference, representation, manipulation, management, and transformation of data formatted according to an ontological construct through the use of a scheme construct. Generally, an M2S construct maps data from the format of an ontological construct to the format of a schematic construct. Together, S2M constructs and M2S constructs can help bring together the efficiencies provided by a schematic construct and those provided by an ontological construct.

Other types of map constructs may also be created from scheme constructs and model constructs. For example, an S2S construct may be created to allow mapping and transformation between one scheme construct and another scheme construct. An S2S construct maps the records in one data store to the records in another data store. Generally, an S2S construct maps data from the format of one schematic construct into the format of another schematic construct.

As another example, an M2M construct may be created to map one model construct to another model construct. Generally, an M2M construct maps data from the format of one ontological construct into the format of another ontological construct. M2M constructs focus on mapping the semantic, or logical, aspects of a data store from one ontological construct to another ontological construct. As such, an M2M construct may provide semantic mapping between model constructs to enable value transformation (e.g. converting Celsius to Fahrenheit), structural transformation (e.g. converting one XML to another), and semantic transformation (e.g. capturing how different communities use the same term) through a single mapping process.

Each of the mapping constructs discussed above may be used to create high complexity maps between different data or data stores, regardless of the format of the construct. A mapping may map one data record to many data records, or conversely many data records may be mapped to one data record, or many data records may be mapped to many data records. Various transformation functions for the model constructs and values may also be provided included as part of a mapping. By way of example, an M2S construct may be used to map a query on the meaning of data to a plurality of queries of multiple data stores having different schematic constructs. In such a scenario, data may be retrieved from the multiple data stores, and then an S2M mapping may be used to translate the data retrieved from the multiple data stores into the format of an ontological construct for presentation to the user.

A construct mapping may take any desired form. By way of example, in certain embodiments, an S2S construct may include the following elements to achieve the desired mapping:
An S2S element identifier, which may also include additional metadata such as date, personnel, or comments.
A record element which specifies a mapping between a given set of source and target records; multiple record mappings may exist in an S2S construct.
A source record element identifier, which specifies the various source records that will be used for the mapping.
A target record element identifier, which specifies the various target records that will be used for the mapping.
A key map element, which maps the source records into one target key. The key may have a hierarchy of data elements coming together to make a unique identifier.
A construct map element, which captures the granular mappings from source to target records for a specified key map element.
A model map element, which captures the mapping at the model level.
A source construct element, which specifies a construct from the source records that is used in this mapping, e.g. attribute; multiple source constructs may be specified.
A target construct element, which specifies a construct from the target records that is used in this mapping, e.g. attribute; multiple target constructs may be specified. The structure of a target construct element is the same as the source construct element.
A value map element, which captures any transformation required between the values of the mapped model elements.
A syntactical element, which specifies a method to transform the model values in any syntactical way, e.g. string operations. Though the syntactical transformation can capture the full gamut of value mapping, it is recommended practice to decompose unit, datatype, and normalization mappings separately.
A normalization element, which specifies any normalization to reference data values. Reference data sources may be implemented as models, in which case normalization may be captured as an S2S mapping.
A datatype element, which itemizes any datatype casting required to map to the target construct.
A unit element, which specifies the unit of measure for the source construct and the unit of measure for the target construct. This element may also specify a method that converts the source to target units.

By way of another example, in certain embodiments, an M2M construct may include the following elements to achieve the desired mapping:
An M2M element identifier, which may also include additional metadata such as date, personnel, or comments.
A record element which specifies a mapping between a given set of source and target ontologies which are bound by a set of restrictions on the source or target side that determine whether the mapping should apply for data or query transform.
A source record element identifier, which specifies the one or more ontologies which will serve as the basis and structure for all source data into the system.
A target record element identifier, which specifies the one or more ontologies which will serve as the basis and structure for all target data out the system.
A mapping element, which identifies mappings to be bound by the source and target restrictions and transformations specified in this construct mapping.
A source restriction element, which specifies the range or restrictions for evaluating any data transformation captured in the construct map. For a query transform, the source restrictions are evaluated (added) on the query regardless of whether any contained mappings are evaluated.
A target restriction element, which specifies the range or restrictions for evaluating any query transformation captured in the construct map. For a data transform, the target restrictions are evaluated (added) on the data regardless of whether any contained mappings are evaluated.
A transformation element, which captures any transformation required between the values of the mapped model elements.
A contained mapping element, which contains a granular level mapping between ontologies. Classes, class properties, and data type properties may mapped in any cardinality desired with arbitrary transformations as needed.
A source construct element, which identifies classes, class properties, and data type properties from the source ontology that is used in this mapping; multiple source constructs may be specified.
A target construct element, which identifies classes, class properties, and data type properties from the target ontology that is used in this mapping; multiple target constructs may be specified. The structure of a target construct element is the same as the source construct element.

S2M and M2S constructs may contain many of the same elements described above, depending upon whether the target and is a schematic construct or an ontological construct and upon whether the source is the other of a schematic construct or an ontological construct. The primary differences between the S2S and M2M constructs described above and S2M and M2S constructs are the actual mappings, since both S2M and M2S map between different types of constructs, whereas both S2S and M2M map between the same types of constructs.

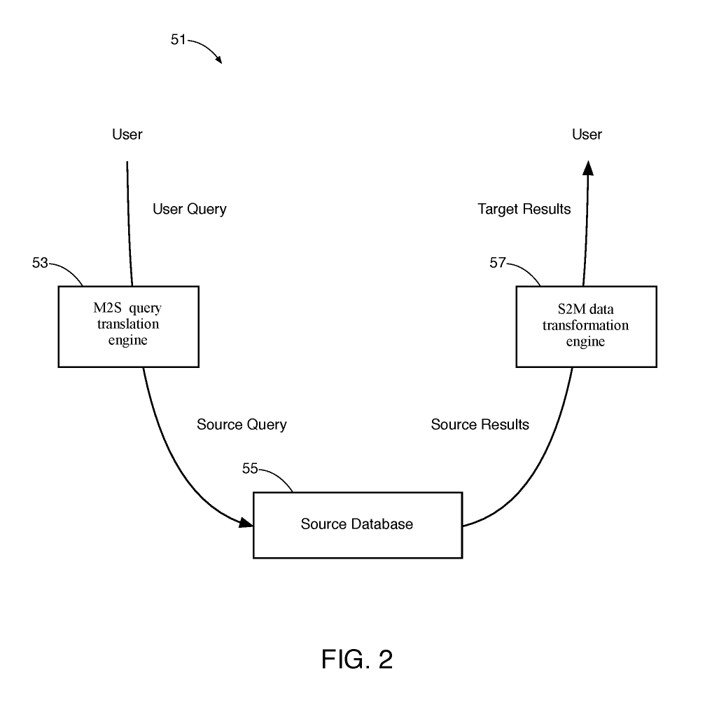

FIG. 2 illustrates the flow of a process 51 using an M2S construct and an S2M construct. To start the process 51, the user creates a user query using a user device. The user query has a target construct, which in the process 51 as shown is an ontological construct. The user query is passed to the M2S query translation engine 53, which applies the construct map of an M2S construct to translate the user query to a source query. The source query has a source construct, which in the process 51 as shown is a schematic construct. The M2S query translation engine 53 may reside on the user device or on a server in communication with both the user device and the source database 55. The source query, in the format of the source construct, is used to query the source database 55 to return the source results. The source results have the source construct, which in the process 51 as shown is the same schematic construct as the source query. The server in this process is used to query the source database 55 with the source query. The source results are passed to the S2M data transformation engine 57, which applies the construct map of an S2M construct to transform the source data to target data. The target data has the target construct, which in the process 51 as shown is the same ontological construct as the user query. The S2M data transformation engine 57 may reside on the user device or on the server. The resulting target data is then returned to the user. This process 51 allows the user to interact with the database 55 using the semantic language of the ontological construct, which as discussed above, may be more efficient for the user.

One or more of the steps of the flowcharts described below may be performed by a programmable processor, which may be the programmable processor of a user device, the programmable processor of a server, or the programmable processor of any other processing device which is communicably coupled, either directly or indirectly, to the subject database.

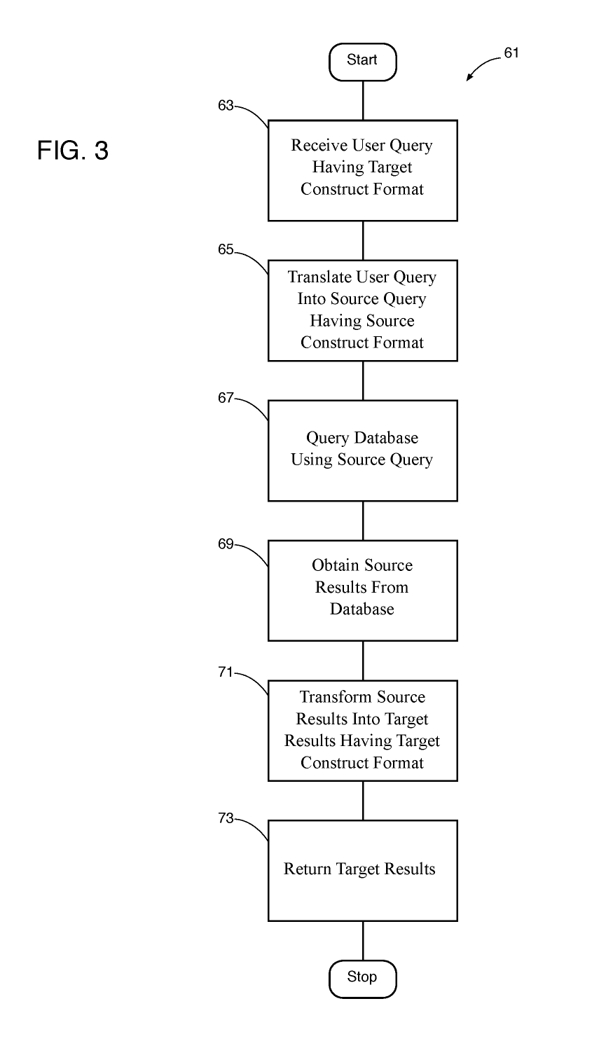

A flowchart 61 showing a process for querying a database is shown in FIG. 3. This flowchart 61 mirrors the process 51 shown in FIG. 2. In the first step shown, a user query is received 63 from a user. The user query is formatted in accordance with a target construct, which is one of a schematic construct or an ontological construct. Next, the user query is translated 65 into a source query, which is formatted in accordance with a source construct, which is the other of a schematic construct or an ontological construct as compared to the user query. The translation 65 of the user query may be achieved using a construct map which defines correspondences between the target construct and the source construct. As described above, the construct map may be part of any one of an S2S construct, and M2M construct, an S2M construct, or an M2S construct. The construct map may include mappings which define at least one correspondence between one or more features of the target construct and one or more features of the source construct. As part of translating 65 the user query into the target query, the restrictions defined by the construct map may be applied to the user query. Such restrictions may be target restrictions, which are defined by the target construct, and/or source restrictions, which are defined by the source construct.

Following the query translation 65, the source query is used to query 67 the database to obtain 69 source results form the database. Both the database and the source results are formatted in accordance with the source construct, the same as the source query. The source results are then transformed 71 into target results which are returned 73 to the user. The target results are formatted in accordance with the target construct, the same as the user query. The transformation 71 of the source results may be achieved using a construct map which defines correspondences between the target construct and the source construct. The construct map used for the transformation 71 of the source results will, in general, be different from the construct map used for the translation 65 of the user query. The construct map used for the transformation 71 of the source results may be achieved using a construct map which defines correspondences between the source construct and the target construct. The construct map used for the transformation 71 of the source results may include mappings which define at least one correspondence between one or more features of the source construct and one or more features of the target construct. As part of transforming 71 the source results into the target results, the restrictions defined by the respective construct map may be applied to the source results. Such restrictions may be source restrictions, which are defined by the source construct, and/or target restrictions, which are defined by the target construct. In certain embodiments, before transforming 71 the source results into the target results, one or more value transformations may be applied to the source results. Such value transformations are defined by the respective construct map.

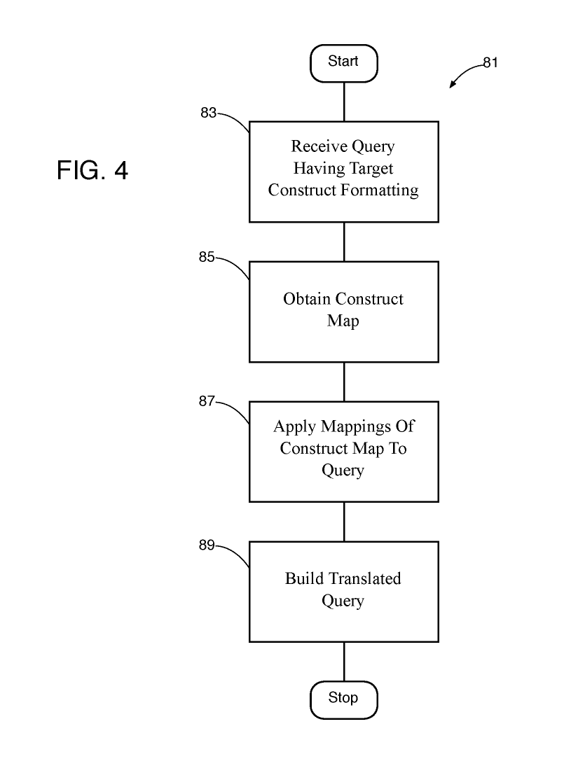

A flowchart 81 showing a query translation process is shown in FIG. 4. This query translation process begins by receiving 83 a query formatted in accordance with a target construct, which may be a schematic construct or an ontological construct. Following receipt 83 of the query, a construct map is obtained 85 for translation of the query. The construct map may be part of any one of an S2S construct, and M2M construct, an S2M construct, or an M2S construct, and the construct map includes one or more mappings which define at least one correspondence between one or more features of the target construct and one or more features of the construct to which the query is being translated. These mappings of the construct map are then applied 87 to the query, and from application 87 of the mappings, the translated query is built 89. The translated query may then be further translated, as needed, or used to query a database. Further translations may be required, for example, if the query is first translated from one ontological construct to another ontological construct, such that further translation into a schematic construct is still needed. Other circumstances may also give rise to the need for further query translations.

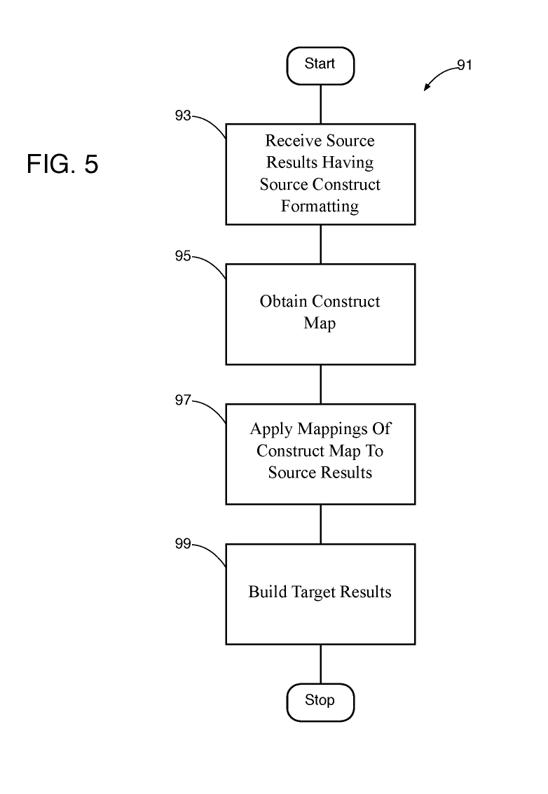

A flowchart 91 showing a data transform process is shown in FIG. 5. This data transformation process begins by receiving 93 data formatted in accordance with a source construct, which may be a schematic construct or an ontological construct. Following receipt 93 of the data, a construct map is obtained 95 for transforming the data. The construct map may be part of any one of an S2S construct, and M2M construct, an S2M construct, or an M2S construct, and the construct map includes one or more mappings which define at least one correspondence between one or more features of the target construct and one or more features of the construct to which the data is being transformed. These mappings of the construct map are then applied 97 to the data, and from application 97 of the mappings, the transformed target data results are built 99. The transformed data may then be further transformed, as needed, or returned to a user. Further transformations may be required, for example, if the data is first transformed from one schematic construct to another schematic construct, such that further translation into an ontological construct is still needed. Other circumstances may also give rise to the need for further data transformations.

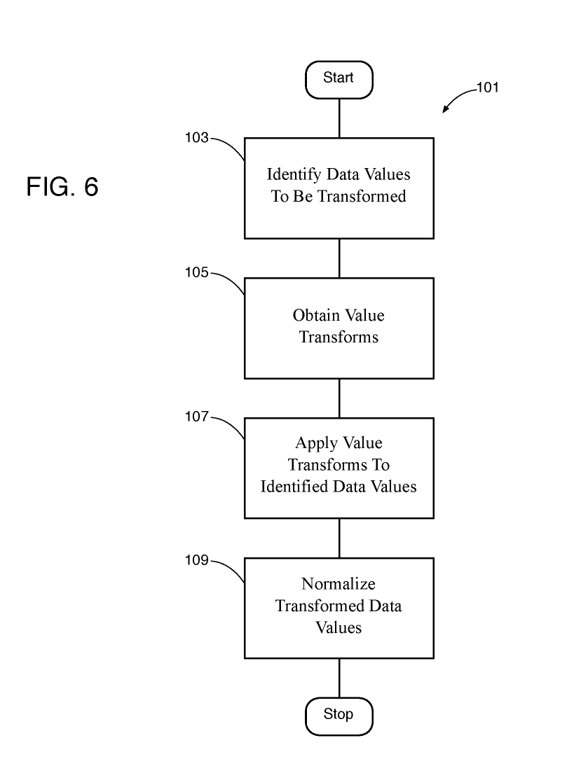

A flowchart 101 showing a value transformation process is shown in FIG. 6. This value transformation process may be incorporated into the data transform process of FIG. 5 during the application of the mappings. The value transformation process begins by identifying 103 data values to be transformed from a first domain to a second domain. By way of example, a value transform may transform a data value from Fahrenheit to Celsius. Next, one or more value transforms, as is needed for the identified data values, is obtained 105. The value transforms are obtained 105 from the construct map which is used to transform data from one type of construct to another type of construct. The obtained 105 value transforms are then applied 107 to the identified data values to transform the values to the desired domain. Following application 107 of the value transforms, the transformed data may then be normalized 109 as appropriate for the data type and/or domain.

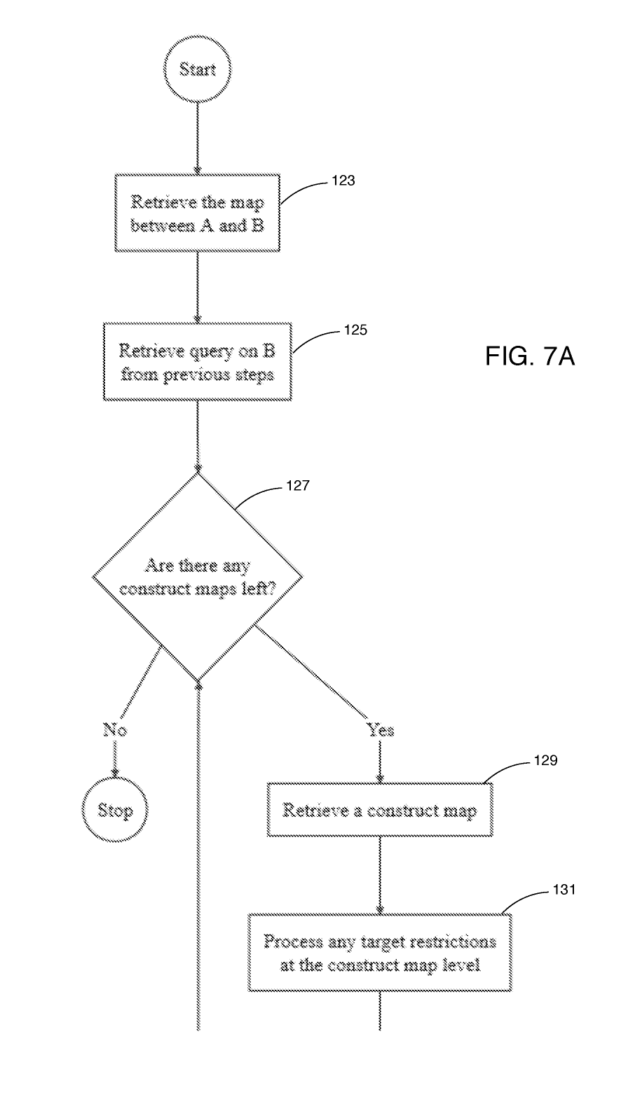

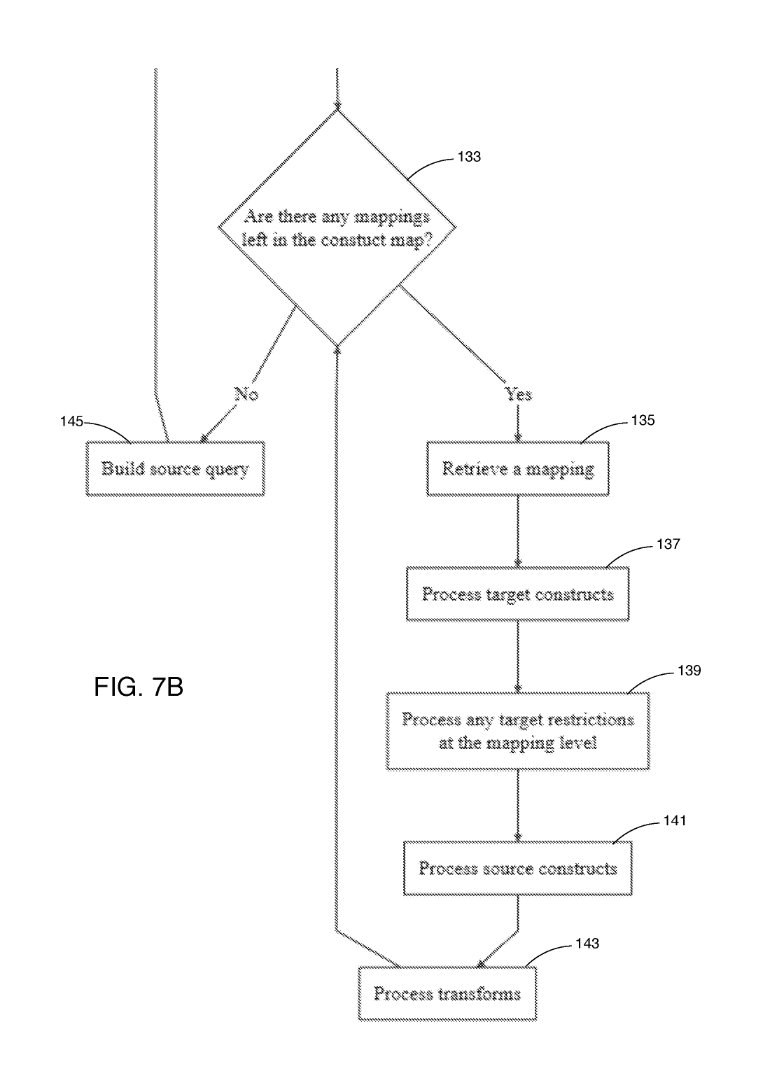

A flowchart showing a second embodiment of a query translation process is shown in FIGS. 7A-B. The flowchart translates a query from construct B to construct A, and there may be one or more constructs interposed within the translation process. The first step of this process as shown involves retrieving 123 the map between construct B and construct A. The map represents one or more translation steps which need to be performed in order to translate a query from construct B to construct A. After retrieving 123 the map, the query is likewise retrieved 125. In practice the steps of retrieving 123 the map and retrieving 125 the query may be performed in any order with respect to each other. Once map and the query are retrieved 123, 125, then the process determines 127 if there are any construct maps remaining to be applied. At the outset of the process, there will be one construct map to apply. Following the first iteration of the process, there will only be more construct maps to apply if there are more than one translation steps to be performed. When there are no more construct maps to apply, the process is complete.

Once it is determined 127 that there is at least one construct map remaining to be applied, then a construct map is retrieved 129 so that it can be applied to the query. For each construct map, any target restrictions at the construct map level are processed 131 and applied to the query. Next, the process determines 133 if there are any mappings left in the construct map to be applied. At the outset of applying a construct map, there will be one mapping to apply. Following the first iteration of the construct map application process, there will only be more mappings to apply if there are ore than one mapping included as part of the construct map. When no mappings remain to be applied, the translated query is built 145. Once it is determined 133 that there is at least one mapping remaining to be applied, then a mapping is retrieved 135 from the construct map. Next, target constructs for each mapping are processed 137, followed by the processing 139 of any target restrictions including at the mapping level. Next, the source constructs are processed 141, and the mapping iteration concludes by performing 143 the translation steps on the query. This iterative process for processing mappings continues until no mappings are left, at which point the translated query is built 145. Additionally, the iterative process for processing map constructs continues until no further map constructs are left, so that the end result may be a translated query having a format in accordance with construct A.

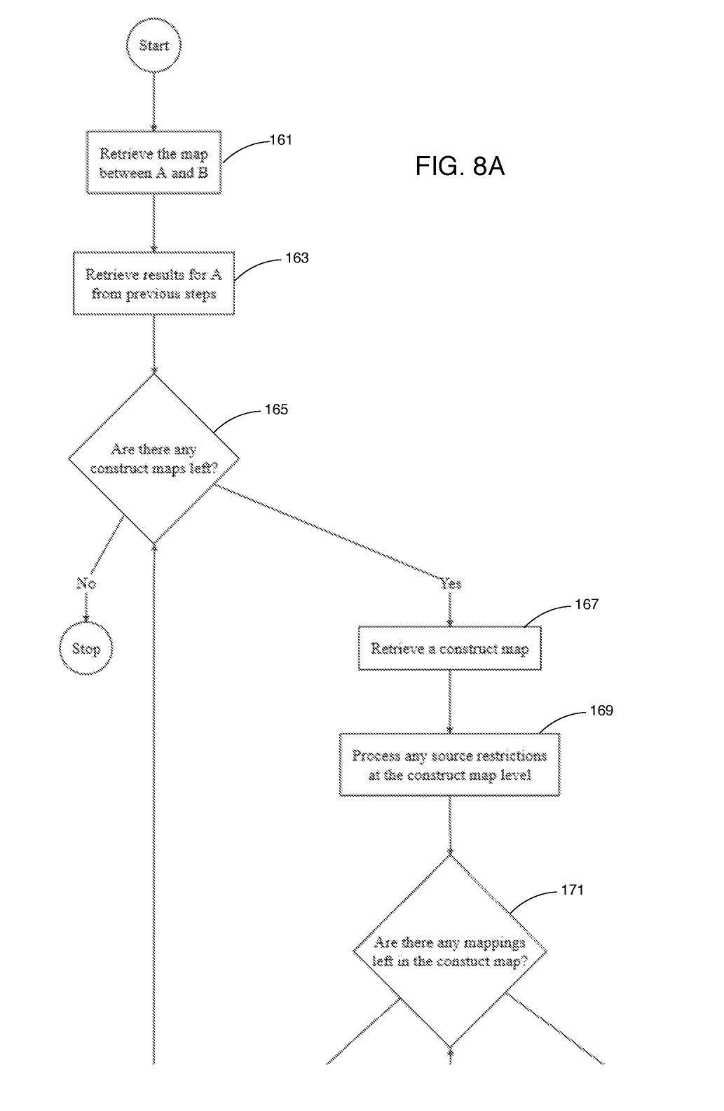

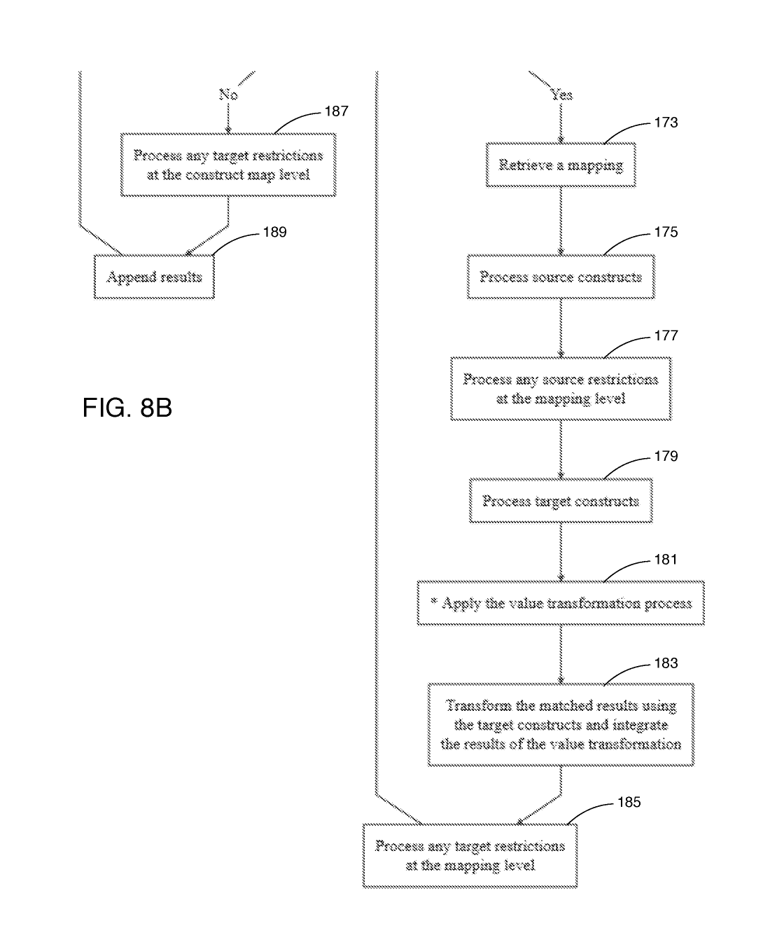

A flowchart showing a second embodiment of a data transformation process is shown in FIGS. 8A-B. The flowchart transforms data from construct A to construct B, and there may be one or more constructs interposed within the transformation process. The first step of this process as shown involves retrieving 161 the map between construct A and construct B. The map represents one or more transformation steps which need to be performed in order to transform data from construct A to construct B. After retrieving 161 the map, the data (e.g., query results) is likewise retrieved 163. In practice the steps of retrieving 161 the map and retrieving 163 the data may be performed in any order with respect to each other. Once map and the data are retrieved 161, 163, then the process determines 165 if there are any construct maps remaining to be applied. At the outset of the process, there will be one construct map to apply. Following the first iteration of the process, there will only be more construct maps to apply if there are more than one transformation steps to be performed. When there are no more construct maps to apply, the process is complete.

Once it is determined 165 that there is at least one construct map remaining to be applied, then a construct map is retrieved 167 so that it can be applied to the data. For each construct map, any source restrictions at the construct map level are processed 169 and applied to the data. Next, the process determines 171 if there are any mappings left in the construct map to be applied. At the outset of applying a construct map, there will be one mapping to apply. Following the first iteration of the construct map application process, there will only be more mappings to apply if there are ore than one mapping included as part of the construct map. When no mappings remain to be applied, any target restrictions at the construct map level are processed 187 and applied to the data, after which the transformed data appended 189 to the results. Once it is determined 171 that there is at least one mapping remaining to be applied, then a mapping is retrieved 173 from the construct map. Next, source constructs for each mapping are processed 175, followed by the processing 177 of any source restrictions included at the mapping level. Next, the target constructs are processed 179, followed by application 181 of any value transformation processes. Next is the actual transformation 183 of the data by using the target constructs and integrating the value transformed data. The mapping iteration concludes with the processing 185 of any target restrictions at the construct mapping level. This iterative process for processing mappings continues until no mappings are left, at which point the transformed data results are built 189. Additionally, the iterative process for processing map constructs continues until no further map constructs are left, so that the end result may be a transformed data having a format in accordance with construct B.

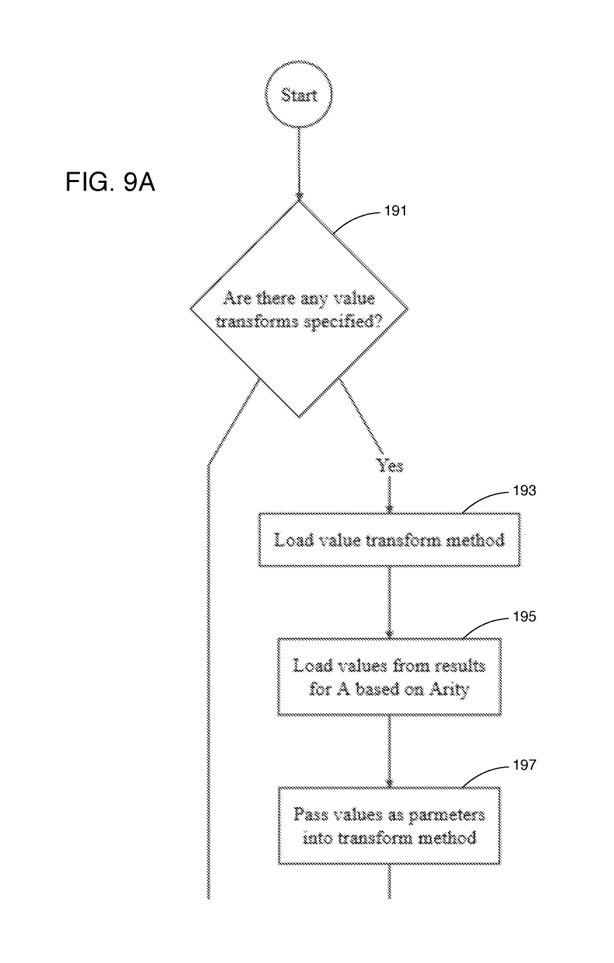

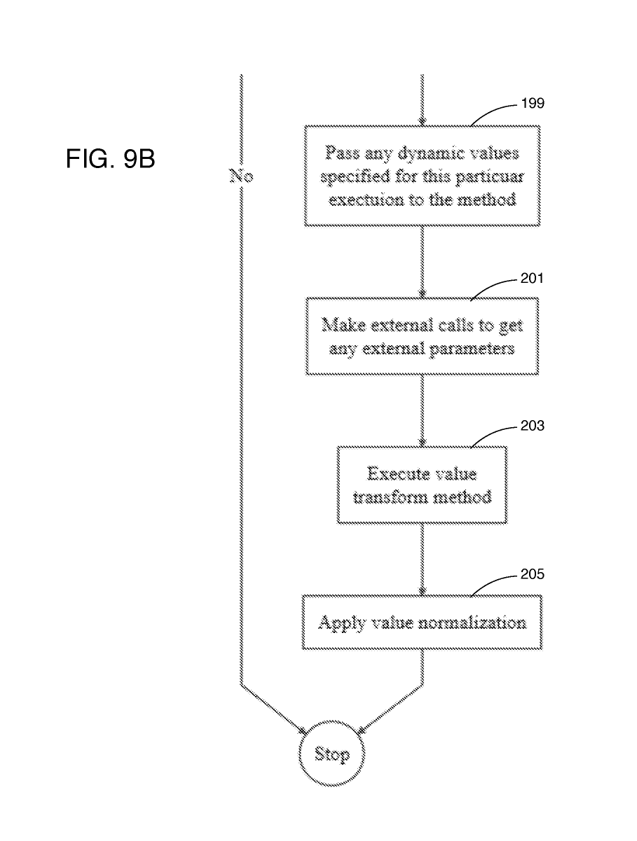

A flowchart showing a second embodiment of a value transformation process is shown in FIGS. 9A-B. This value transformation process may be incorporated into the data transform process of FIGS. 9A-B during the application of the mappings. The value transformation process begins by identifying 191 data values to be transformed from a first domain to a second domain. Next, the value transform method is obtained 193, and the values to be transformed are also obtained 195. In practice the steps of obtaining 193 the value transform method and obtaining 195 the values to be transformed may be performed in any order with respect to each other. The values to be transformed are then passed 197 as parameters into the value transform method. Any dynamic values specified for the particular execution of the value transform method are also passed 199 as parameters into the value transform method. External calls are also made 201 to obtain any external parameters required by the value transform method. Next, the value transform method is executed 203 and any value normalization, as appropriate or called for, is applied 205. The transformed values may then be passed back to the data transform process to be incorporated into the transformed data.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A method of querying a database, the method comprising:
receiving, from a user device, a user query formatted in accordance with a target construct, the target construct having one of an ontological construct or a schematic construct;
translating the user query into a source query formatted in accordance with a source construct, the source construct having the other of the ontological construct or the schematic construct;
querying, using a programmable processor, a database using the source query and obtain source results from the database, the database and the source results formatted in accordance with the source construct;
transforming the source results into target results formatted in accordance with the target construct; and
returning, to the user device, the target results.

2. The method of claim 1, wherein translating the user query into the source query comprises translating the user query into the source query using a construct map, the construct map defining correspondences between the target construct and the source construct.

3. The method of claim 2, wherein the construct map comprises a plurality of mappings, each mapping defining at least one correspondence between one or more features of the target construct and one or more features of the source construct.

4. The method of claim 2, wherein translating the user query into the source query comprises applying target restrictions defined by the construct map.

5. The method of claim 1, wherein transforming the source results into the target results comprises transforming the source results into the target results using a construct map, the construct map defining correspondences between the target construct and the source construct.

6. The method of claim 5, wherein the construct map comprises a plurality of mappings, each mapping defining at least one correspondence between one or more features of the target construct and one or more features of the source construct.

7. The method of claim 5, wherein before transforming the source results into target results, the method further comprises applying one or more value transformations to the source results, the one or more value transformations defined by the construct map.

8. The method of claim 5, wherein translating the source results into the target results comprises applying source restrictions defined by the construct map.

9. A method of querying a database, the method comprising:
receiving, from a user device, a user query formatted in accordance with a target construct, the target construct having one of an ontological construct or a schematic construct;
translating the user query into a source query formatted in accordance with a source construct, the source construct having the other of the ontological construct or the schematic construct; and
querying, using a programmable processor, a database using the source query to return source results from the database, the database and the source results formatted in accordance with the source construct.

10. The method of claim 9, wherein translating the user query into the source query comprises translating the user query into the source query using a construct map, the construct map defining correspondences between the target construct and the source construct.

11. The method of claim 10, wherein the construct map comprises a plurality of mappings, each mapping defining at least one correspondence between one or more features of the target construct and one or more features of the source construct.

12. The method of claim 10, wherein translating the user query into the source query comprises applying target restrictions defined by the construct map.

13. A method of retrieving query results from a database, the method comprising:
querying, using a programmable processor, the database using a source query, the query returning source results from the database, the database and the source results formatted in accordance with a source construct, the source construct having one of an ontological construct or a schematic construct;
transforming the source results into target results formatted in accordance with a target construct, the target construct having the other of the ontological construct or the schematic construct; and
returning, to a querying device, the target results.

14. The method of claim 13, wherein transforming the source results into the target results comprises transforming the source results into the target results using a construct map, the construct map defining correspondences between the target construct and the source construct.

15. The method of claim 14, wherein the construct map comprises a plurality of mappings, each mapping defining at least one correspondence between one or more features of the target construct and one or more features of the source construct.

16. The method of claim 14, wherein before transforming the source results into target results, the method further comprises applying one or more value transformations to the source results, the one or more value transformations defined by the construct map.

17. The method of claim 14, wherein translating the source results into the target results comprises applying source restrictions defined by the construct map.
